(19) United States
(12) Patent Application Publication
(10) Pub. No.: US 2026/0077796 A1
(43) Pub. Date: Mar. 19, 2026

(54) Foldable Sleeping Basket and Stroller Comprising Same

(71) Applicant: Zhejiang Jinhua Snowbaby Baby Items Manufacturing Co., Ltd., Lanxi (CN)

(72) Inventors: Pin Qi Wang, Lanxi (CN); Sheng Jun Meng, Lanxi (CN); Chuan Xi Hu, Lanxi (CN)

(21) Appl. No.: 19/006,669

(22) Filed: Dec. 31, 2024

(30) Foreign Application Priority Data
Sep. 14, 2024 (CN) 2024222611764

(51) Int. Cl. B62B 7/06; B62B 9/10

(52) U.S. Cl. CPC B62B 7/06; B62B 9/102

(57) ABSTRACT

An apparatus and assembly including a foldable sleeping basket such as used for a child to sleep, and which can include a stroller such as used to transport a child. The sleeping basket can include a plurality of frame sections coupled to folding members in an upper and a lower frame thereof. The folding sleeping basket can be mechanically secured to said stroller in some aspects.

### RELATED APPLICATIONS

This application claims the benefit and priority of Chinese Patent Application Serial No. 2024222611764, filed on Sep. 14, 2024, which is hereby incorporated by reference.

### TECHNICAL FIELD

The present disclosure relates to a children's mobility tool, in particular to a foldable sleeping basket and a stroller comprising the foldable sleeping basket.

### BACKGROUND

Some strollers are popular with consumers because they can accommodate both child seats and sleeping baskets for younger babies. Most sleeping baskets designed to fit existing strollers rely on the top and bottom frames for up-and-down compression to achieve folding. However, their length cannot be folded, and the cloth cover on the foldable sleeping basket must be removed. Additionally, the rod must be manually operated to release the support between the top and bottom frames, making the process cumbersome. A small number of sleeping baskets can fold lengthwise using a two-stage folding mechanism, resulting in a V-shaped configuration. However, because the pole and folding joint take up space, the end of the pole farthest from the folding joint has a larger opening angle when folded, occupying additional space. Furthermore, excessive compression can damage the cloth cover at the joints. Therefore, an improved apparatus is useful to facilitate safe placement and/or transporting of a child or other item placed within the invention as described.

### SUMMARY

Embodiments of the invention provide a foldable sleeping basket and a stroller comprising the foldable sleeping basket in order to solve the existing technical problems that the end of the sleeping basket pole away from the folding joint has a larger opening angle, a certain amount of space is occupied and forcible compression may damage the cloth cover at the joints after the sleeping basket is folded and closed.

An embodiment comprises a foldable sleeping basket is provided, which comprises an upper frame, a lower frame and a folding assembly. The upper frame comprises a first upper frame, a second upper frame, and a first bendable part, wherein, the first upper frame is connected with the second upper frame via the first bendable part. The first upper frame and the second upper frame can be respectively folded towards each other via the rotating point at the connection with the first bendable part. The lower frame comprises a first lower frame, a second lower frame and a third lower frame, wherein, the first lower frame can be rotated and connected with one end of the third lower frame, the second lower frame can be rotated and connected with the other end of the third lower frame, and the first lower frame and the second lower frame can be respectively folded towards each other via the rotating point at the connection with the third lower frame. The foldable assembly comprises a first foldable part and a second foldable part, wherein, the first foldable part is arranged between the first upper frame and the first lower frame, and the second foldable part is arranged between the second upper frame and the second lower frame. When the first upper frame and the second upper frame are folded towards each other, the first lower frame and the second lower frame are folded towards each other driven by the first foldable part and the second foldable part.

In this plan, the first upper frame is connected with the second upper frame via the first bendable part, and can also be folded upward via the rotation point at the connection with the first bendable part. The first lower frame and the second lower frame can be respectively folded towards each other via the rotation point at the connection with the third lower frame. In addition, a first foldable part is arranged between the first upper frame and the first lower frame, and a second foldable part is arranged between the second upper frame and the second lower frame. When the first upper frame is folded upward via the rotation point at the connection with the first bendable part, the first foldable part drives the first lower frame to be folded upward via the rotating point at the connection with the third lower frame. Similarly, when the second upper frame is folded upward, the second upper frame drives the 3nd lower frame to be folded downward to reduce the space occupied by the sleeping basket for the ease of storage. When it is necessary to unfold the foldable sleeping basket for use, the first upper frame and the second upper frame are pulled, which drives the unfolding of the first lower frame and the second lower frame. As the third lower frame is arranged between the first lower frame and the second lower frame, the lower frame is folded in three sections, and the third lower frame makes more accommodation space between the first lower frame and the second lower frame. For one thing, after being folded, the first lower frame, the second lower frame and the third lower frame are in the U shape. Compared to the two-section V-shape frame, less space is occupied. For another, the head and the cloth cover are less prone to be damaged due to extrusion and are flatter after the sleeping basket is folded.

Preferably, the foldable sleeping basket also comprises a locking mechanism. The locking mechanism is used to lock the first bendable part to prevent the first upper frame and the second upper frame from being folded, as well as the first lower frame and the second lower frame.

In this plan, when the sleeping basket is unfolded for use, the locking mechanism locks the first bendable part, and the first upper frame and the second lower frame cannot be folded. As the first lower frame and the second lower frame are linked to the first upper frame and the second upper frame via the first foldable part and the second foldable part, when the first upper frame and the second upper frame cannot be folded, the first lower frame and the second lower frame cannot be folded, either. Compared with depending on the fastening extent of the rotating point to maintain the use status of the sleeping basket, the above structure is safer and more stable.

Preferably, an unlocking mechanism is arranged on the upper frame or the lower frame, and the unlocking mechanism can unlock the locking mechanism.

In this plan, an unlocking mechanism is arranged on the upper frame and the lower frame. Compared with unlocking the locking mechanism on both sides manually, even putting aside the cloth cover on the sleeping basket to operate the first foldable part and the second foldable part, this operation is more convenient and easier.

Preferably, the first foldable part comprises a first connecting rod and a first supporting rod, wherein, one end of the first supporting rod can be rotated and connected with the first upper frame, and the other end of the first supporting rod can be rotated and connected with the third lower frame. The first connecting rod comprises a first sub-rob, a second sub-rod and a third sub-rod, wherein, the middle part of the third sub-rod can be rotated and connected with the middle part of the first supporting rod, one end of the third sub-rod can be rotated and connected with one end of the first sub-rod, the other end of the third sub-rod can be rotated and connected with one end of the second sub-rod, the other end of the first sub-rod can be rotated and connected with the part of the first bendable part in proximity to the first bendable part, and the other end of the second sub-rod can be rotated and connected with the part of the third lower frame away from the third lower frame. The second foldable part comprises a second connecting rod, wherein, one end of the second connecting rod can be rotated and connected with the second upper frame, and the other end of the second connecting rod can be rotated and connected with the second lower frame.

In this plan, when the second upper frame is folded upward, the second lower frame is driven to be folded upward. At the same time, the second upper frame applies a downward force to the end of the first upper frame in proximity to the first bendable part to drive the first sub-rod to move downward via the first bendable part. In addition, the middle part of the third sub-rod can be rotated and connected with the middle part of the first supporting rod. When the first sub-rod moves downward, the third sub-rod is driven to be rotated at the connection between the third sub-rod and the first supporting rod. As the third sub-rod can be rotated and connected with the second sub-rod, the first sub-rod can be rotated and connected with the first upper frame, and the second sub-rod can be rotated and connected with the first lower frame. When the third sub-rod rotates, the second sub-rod is pulled to drive the first lower frame folded upward. Moreover, the first supporting rod is fixed and connected with the third lower frame, in the folded state, the first upper frame, the second upper frame, the first lower frame and the second lower frame are in the same angle of inclination with the first supporting rod so that the sleeping basket can be tilted towards one direction to fit in the vehicle frame for the convenience of storage.

Preferably, the second foldable part also comprises a third connecting rod, wherein, one end of the third connecting rod can be rotated and connected with the second upper frame, and the other end of the third connecting rod can be rotated and connected with the third lower frame.

In this plan, the other end of the third connecting rod can be rotated and connected with the third lower frame. The connections between the second foldable part and the upper/lower frame are disperse with even stress. Therefore, the structure is more stable and reliable, less prone to deformation.

Preferably, the first foldable part comprises a first connecting rod, wherein, one end of the first connecting rod can be rotated and connected with the first upper frame, and the other end of the first connecting rod can be rotated and connected with the first lower frame.

In this plan, the first foldable part links to the folding motion of the first upper frame and the first lower frame via the first connecting rod arranged between the first upper frame and the first lower frame, with simple structure and lower production cost.

Preferably, the first foldable part also comprises a second connecting rod, wherein, one end of the second connecting rod can be rotated and connected with the first upper frame, and the other end of the second connecting rod can be rotated and connected with the connection between the first lower frame and the third lower frame.

In this plan, the other end of the second connecting rod can be rotated and connected with the connection between the first lower frame and the third lower frame. The connections between the first foldable part and the upper/lower frame are disperse with even stress. Therefore, the structure is more stable and reliable, less prone to deformation.

Preferably, the second foldable part is arranged symmetrically with the first foldable part.

In this plan, the second foldable part is arranged symmetrically with the first foldable part. The sleeping basket is simple in structure and low in production cost.

Preferably, the first foldable part comprises a first connecting rod and a second connection rod, wherein, one end of the second connecting rod can be rotated and connected with the first upper frame, and the other end of the second connecting rod can be rotated and connected with the connection between the first lower frame and the third lower frame. The first connecting rod comprises a first sub-rob, a second sub-rod and a third sub-rod, wherein, the middle part of the third sub-rod can be rotated and connected with the middle part of the second connecting rod, one end of the third sub-rod can be rotated and connected with one end of the first sub-rod, the other end of the third sub-rod can be rotated and connected with one end of the second sub-rod, the other end of the first sub-rod can be rotated and connected with the part of the first upper frame in proximity to the first bendable part, and the other end of the second sub-rod can be rotated and connected with the part of the first lower frame away from the third lower frame.

In this plan, both ends of the second connecting rod can be rotated and connected with the first upper frame and the connecting between the first lower frame and the third lower frame. When the first upper frame is folded upward, the second connecting rod is driven to rotate via the rotating point at the connection between the first lower frame and the third lower frame. In addition, the middle part of the third sub-rod can be rotated and connected with the middle part of the second connecting rod. When the second connecting rod rotates, the third sub-rod is driven to rotate at the connection between the third sub-rod and the second connecting rod. As the third sub-rod can be rotated and connected with the first sub-rod and the second sub-rod, the first sub-rod can be rotated and connected with the first upper frame, and the second sub-rod can be rotated and connected with the first lower frame, when the third sub-rod rotates, the second sub-rod is pulled to drive the first lower frame be folded upward. In the structure, the first foldable part is in the X shape, with even stress at the connections with the first upper frame and the first lower frame. The structure is more stable and reliable.

Preferably, the second foldable part is arranged symmetrically with the first foldable part.

The second foldable part is arranged symmetrically with the first foldable part. The sleeping basket is simple in structure and low in production cost.

A stroller, which also comprises a foldable sleeping basket. The stroller preferably comprises a stroller frame, coupled or attached to which is a stroller handle proximal to an upper portion thereof for pushing the stroller. The stroller further includes a plurality of stroller wheels proximal to a lower portion thereof for rolling and transporting the stroller over a ground surface. The stroller includes a plurality of mechanical coupling points configured for attachment or coupling or securing to a corresponding plurality of mechanical coupling points on a foldable sleeping basket in a preferred embodiment.

In this plan, for the sleeping basket on the stroller, the first upper frame is connected with the second upper frame via the first bendable part, and can also be folded upward via the rotation point at the connection with the first bendable part. The first lower frame and the second lower frame can be respectively folded towards each other via the rotation point at the connection with the third lower frame. In addition, the first bendable part is arranged between the first upper frame and the first lower frame, and the second bendable part is arranged between the second upper frame and the second lower frame. When the first upper frame is folded upward via the rotation point at the connection with the first bendable part, the first foldable part drives the first lower frame to be folded upward via the rotating point at the connection with the third lower frame. Similarly, when the second upper frame is folded upward, the second lower frame is driven to be folded downward to reduce the space occupied by the sleeping basket for the ease of storage. When it is necessary to unfold the foldable sleeping basket for use, the first upper frame and the second upper frame are pulled, which drives the unfolding of the first lower frame and the second lower frame. As the third lower frame is arranged between the first lower frame and the second lower frame, the lower frame is folded in three sections, and the third lower frame makes more accommodation space between the second lower frame and the second lower frame. For one thing, after being folded, the first lower frame, the second lower frame and the third lower frame are in the U shape. Compared to the two-section V-shape frame, less space is occupied. For another, the head and the cloth cover are less prone to be damaged due to extrusion and are flatter after the sleeping basket is folded.

An aspect is directed to a foldable sleeping basket comprising an upper frame having a first upper frame portion, a second upper frame portion, said first and second upper frame portions being foldable towards one another by way of a lockable upper frame pivot assembly; a lower frame having a first lower frame portion, a second lower frame portion, and a third lower frame portion, said first and third lower frame portions being foldable towards each other by way of a first lower frame pivot assembly joining the first and second lower frame portions and a second lower frame pivot assembly joining the third and second lower frame portions, respectively; a frame connector assembly comprising a plurality of connecting rods and sub-rods mechanically coupling said upper frame portions and said lower frame portions to one another; said foldable sleeping basket being foldably transitionable between an extended state and a collapsed state; wherein in the extended state the foldable sleeping basket the first and second upper frame portions are open about said upper frame pivot assembly and the lockable upper frame pivot assembly is locked, and wherein the first, second and third lower frame portions are open about said first and second lower frame pivot assemblies; and wherein in the collapsed state the foldable sleeping basket the first and second upper frame portions are folded towards one another about said upper frame pivot assembly and the lockable upper frame pivot assembly is unlocked, and wherein the first, second and third lower frame portions are folded towards one another about said first and second lower frame pivot assemblies, respectively.

An aspect is directed to said foldable sleeping basket, configured and arranged to mechanically lock into a mobile stroller for transporting the same.

An aspect is directed to said foldable sleeping basket, said lockable upper frame pivot assembly preventing movement from said extended state to said collapsed state.

An aspect is directed to said foldable sleeping basket, further comprising an unlocking mechanism for unlocking said lockable upper frame pivot assembly, which permits movement from said extended state to said collapsed state.

An aspect is directed to said foldable sleeping basket, wherein said frame connector assembly couples at least one or more of said plurality of connecting rods and sub-rods to upper frame coupling points on said upper frame and to lower frame coupling points on said lower frame.

An aspect is directed to said foldable sleeping basket, wherein at least one of said plurality of connecting rods and sub-rods comprise rotatable mechanical endpoints to permit pivoting movement of said at least one of said plurality of connecting rods and sub-rods with respect to another member of said upper or lower frames.

And an aspect is directed to a stroller, comprising a wheeled transportation frame, a handle, and the foldable sleeping basket as described herein.

Yet another aspect is directed to a foldable stroller and sleeping basket apparatus, comprising a stroller frame having a plurality of stroller frame coupling points configured to mechanically couple to a corresponding plurality of folding basket coupling points; a stroller handle proximal to an upper portion of said stroller frame; a plurality of stroller wheels proximal to a lower portion of said stroller frame; and a foldable sleeping basket comprising an upper sleeping basket frame and a lower sleeping basket frame; wherein said upper sleeping basket frame includes a first upper frame portion, a second upper frame portion, said first and second upper frame portions being foldable towards one another by way of a lockable upper frame pivot assembly; wherein said lower basket frame includes a first lower frame portion, a second lower frame portion, and a third lower frame portion, said first and third lower frame portions being foldable towards each other by way of a first lower frame pivot assembly joining the first and second lower frame portions and a second lower frame pivot assembly joining the third and second lower frame portions, respectively; wherein said foldable sleeping basket is foldably transitionable between an extended state and a collapsed state; wherein in the extended state the foldable sleeping basket the first and second upper frame portions are open about said upper frame pivot assembly and the lockable upper frame pivot assembly is locked, and wherein the first, second and third lower frame portions are open about said first and second lower frame pivot assemblies; and wherein in the collapsed state the foldable sleeping basket the first and second upper frame portions are folded towards one another about said upper frame pivot assembly and the lockable upper frame pivot assembly is unlocked, and wherein the first, second and third lower frame portions are folded towards one another about said first and second lower frame pivot assemblies, respectively.

### BRIEF DESCRIPTION OF THE DRAWINGS

FIG. 1 illustrates a structural aspect of a sleeping basket as a side view;

FIG. 2 illustrates a structural aspect of a sleeping basket as a perspective view in an expanded view;

FIG. 3 illustrates a folding aspect of a sleeping basket;

FIG. 4 illustrates a folding aspect of a sleeping basket in a collapsed state;

FIG. 5 illustrates an aspect of the folding sleeping basket and baby stroller assembly in an expanded state;

FIG. 6 illustrates an aspect of the folding sleeping basket and baby stroller in a collapsed state;

FIG. 7 illustrates another structural aspect of a foldable sleeping basket in a side view;

FIG. 8 illustrates a structural aspect of a foldable sleeping basket in a perspective view in an expanded state;

FIG. 9 illustrates an aspect of a folding sleeping basket;

FIG. 10 illustrates an aspect of a foldable sleeping basket in a side view;

FIG. 11 illustrates an aspect of a foldable sleeping basket in an extended state in a perspective view;

FIG. 12 illustrates an aspect of a folding sleeping basket.

### DETAILED DESCRIPTION

One or more preferred embodiments are described herein, which are understood together with the attached drawings. The present disclosure describes a sleeping basket into which a child or other living being or any object could be placed. The sleeping basket is therefore descriptive of an exemplary use of the invention and the term should be read broadly as it can be applied and used for various purposes not limited to the safe securement, transportation or resting of a child.

In various aspects, the disclosure describes a foldable nature of said sleeping basket. The foldable nature allowing convenient and compact storage or transportation of the apparatus. For example, the foldable sleeping basket can be open in a first (e.g., extended) state, or it can be closed or folded up when not in use in a second (e.g., collapsed) state. The two states of the apparatus can be achieved by properly unlocking and pivotably rotating the various mechanical members about respective pivot assemblies as illustrated and described. This bending or folding or pivoting movement allows for transitioning between the extended and collapsed states of the foldable sleeping basket.

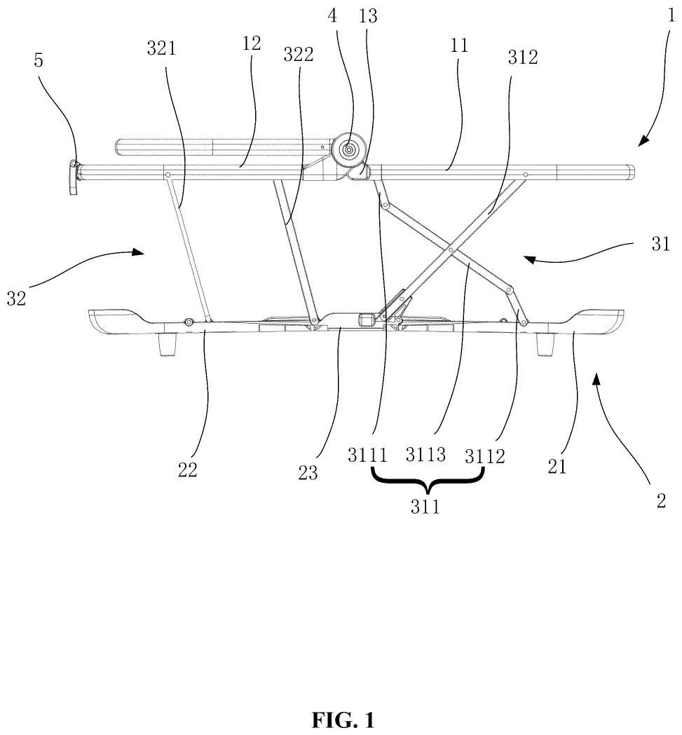

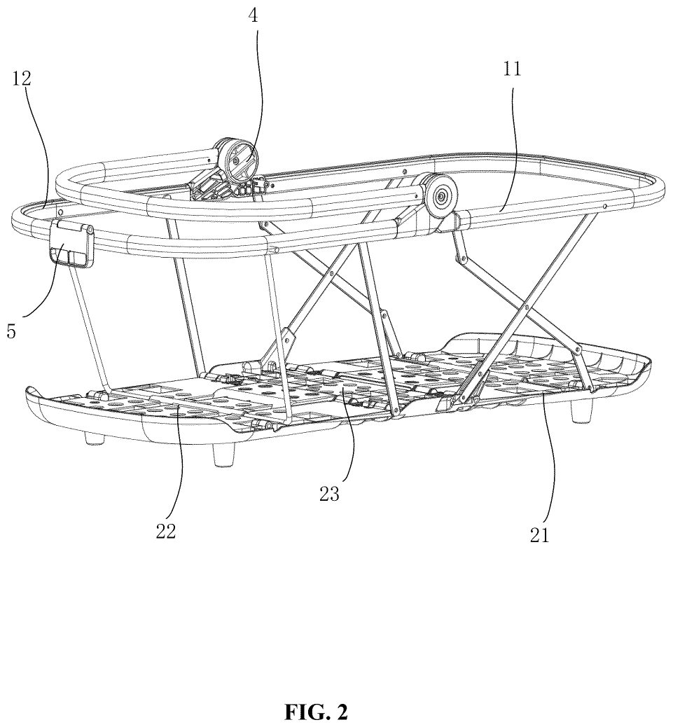

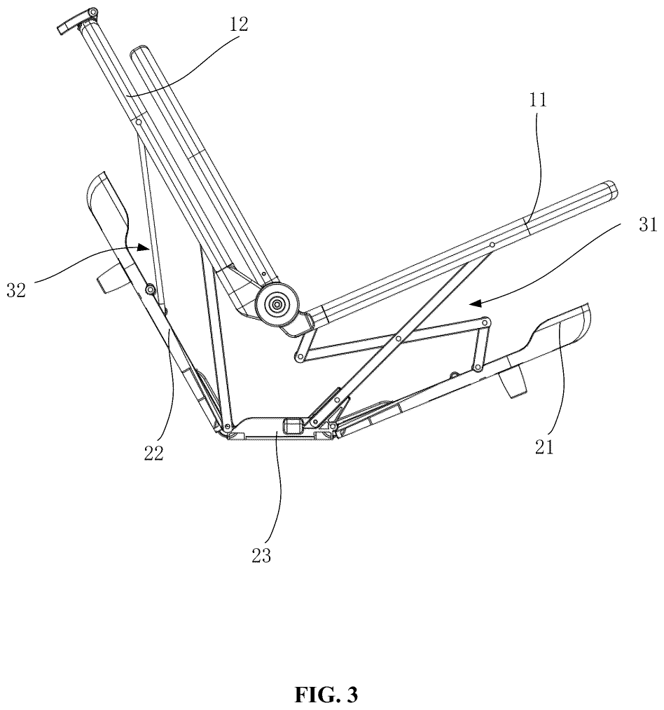

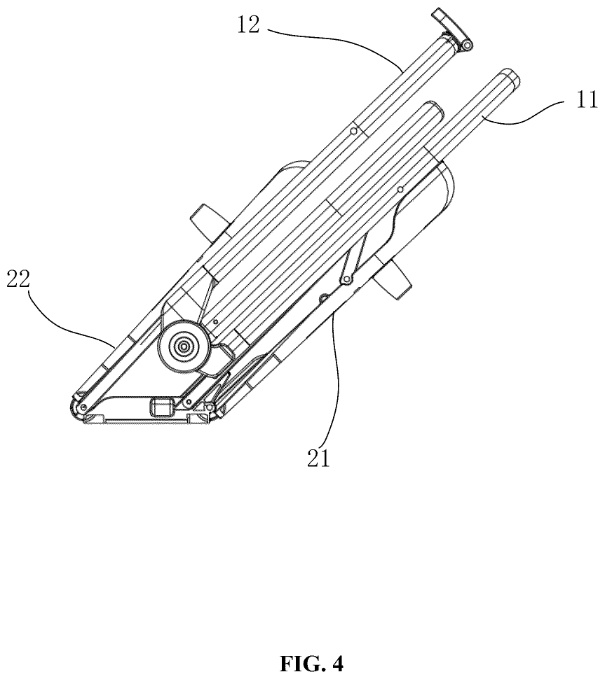

FIGS. 1 through 6 illustrate an embodiment comprising a foldable sleeping basket, which comprises an upper frame (1), a lower frame (2) and a folding assembly. The upper frame (1) comprises a first upper frame (11), a second upper frame (12), and a first bendable part (13), wherein, the first upper frame (11) is connected with the second upper frame (12) via the first bendable part (3). The first upper frame (11) and the second upper frame (12) can be folded towards each other via the rotating point at the connection with the first bendable part (13). The lower frame (2) comprises a first lower frame (21), a second lower frame (22) and a third lower frame (23), wherein, the first lower frame (21) can be rotated and connected with one end of the third lower frame (23), the second lower frame (22) can be rotated and connected with the other end of the third lower frame (23), and the first lower frame (21) and the second lower frame (22) can be respectively folded towards each other via the rotating point at the connection with the third lower frame (23). The foldable assembly comprises a first foldable part (31) and a second foldable part (32), wherein, the first foldable part (31) is arranged between the first upper frame (11) and the first lower frame (21), and the second foldable part (32) is arranged between the second upper frame (12) and the second lower frame (22). When the first upper frame (11) and the second upper frame (21) are folded towards each other, the first lower frame (21) and the second lower frame (22) are folded towards each other driven by the first foldable part (31) and the second foldable part (32).

In this plan, the first upper frame (11) is connected with the second upper frame (12) via the first bendable part (13), and can also be folded upward via the rotation point at the connection with the first bendable part (13). The first lower frame (21) and the second lower frame (22) can be respectively folded towards each other via the rotation point at the connection with the third lower frame (23). In addition, the first foldable part (31) is arranged between the first upper frame (11) and the first lower frame (21), and the second foldable part (32) is arranged between the second upper frame (12) and the second lower frame (22). When the first upper frame (11) is folded upward via the rotation point at the connection with the first bendable part (13), the first foldable part (31) drives the first lower frame (21) to be folded upward via the rotating point at the connection with the third lower frame (23). Similarly, when the second upper frame (12) is folded upward, the second lower frame (22) is driven to be folded downward to reduce the space occupied by the sleeping basket for the ease of storage. When it is necessary to unfold the foldable sleeping basket for use, the first upper frame (11) and the second upper frame (12) are pulled, which drives the folding of the first lower frame (21) and the second lower frame (22). As the third lower frame (23) is arranged between the first lower frame (21) and the second lower frame (22), the lower frame (2) is folded in three sections. Of course, in other embodiments, the third lower frame (23) may be of a two or more section structure, with more smooth transition at the bend. The third lower frame (23) makes more accommodation space between the first lower frame (21) and the second lower frame (22). For one thing, after being folded, the first lower frame (21), the second lower frame (22) and the third lower frame (23) are paralleled, in the U shape. Compared to the two-section V-shape frame, less space is occupied. For another, the head and the cloth cover are less prone to be damaged due to extrusion and are flatter after the sleeping basket is folded. Of course, in other embodiments, a fourth upper frame can also be arranged between the first upper frame (11) and the second upper frame (12) to provide better effect after folding.

In an aspect, the foldable sleeping basket also comprises a locking mechanism (4). The locking mechanism (4) is used to lock the first bendable part (13) to prevent the first upper frame (11) and the second upper frame (12) from being folded, as well as the first lower frame (21) and the second lower frame (22).

In this plan, when the sleeping basket is unfolded for use, the locking mechanism locks the first bendable part (13), and the first upper frame (11) and the second lower frame (12) cannot be folded. As the first lower frame (21) and the second lower frame (22) are linked to the first upper frame (11) and the second upper frame (12) via the first foldable part (31) and the second foldable part (32), when the first upper frame (11) and the second upper frame (12) cannot be folded, the first lower frame (21) and the second lower frame (22) cannot be folded, either. Compared with the use of state which maintains the sleeping basket depending on the fastening extent of the rotating point, the structure is safer and more stable. Of course, in other embodiments, the locking mechanism (4) can also be arranged on the third lower frame (23) to lock the third lower frame (23), or arranged on both the first bendable part (13) and the third lower frame (23), to realize the effect above.

In an exemplary embodiment, an unlocking mechanism (5) is arranged on the upper lower frame (1), and the unlocking mechanism (5) can unlock the locking mechanism (4).

In this plan, an unlocking mechanism (5) is arranged on the upper frame (5). Compared with unlocking the locking mechanism (4) on both sides manually, even putting aside the cloth cover on the sleeping basket to operate the first foldable part (31) and the second foldable part (32), this operation is more convenient and easier.

In another non-limiting aspect, the first foldable part (31) comprises a first connecting rod (311) and a first supporting rod (312), wherein, one end of the first supporting rod (312) can be rotated and connected with the first upper frame (11), and the other end of the first supporting rod (312) can be rotated and connected with the third lower frame (23). The first connecting rod (311) comprises a first sub-rob (3111), a second sub-rod (3112) and a third sub-rod (3113), wherein, the middle part of the third sub-rod (3113) can be rotated and connected with the middle part of the first supporting rod (312), one end of the third sub-rod (3113) can be rotated and connected with one end of the first sub-rod (3111), the other end of the third sub-rod (3113) can be rotated and connected with one end of the second sub-rod (3112), the other end of the first sub-rod (3111) can be rotated and connected with the part of the first upper frame (11) in proximity to the first bendable part (13), and the other end of the second sub-rod (3112) can be rotated and connected with the part of the first lower frame (21) away from the third lower frame (23). The second foldable part (32) comprises a second connecting rod (321), wherein, one end of the second connecting rod (321) can be rotated and connected with the second upper frame (12), and the other end of the second connecting rod (321) can be rotated and connected with the second lower frame (22).

In this exemplary aspect, the first upper frame (11) is connected with the second upper frame (12) via the first bendable part (13), and can also be folded upward via the rotation point at the connection with the first bendable part (13). The first lower frame (21) and the second lower frame (22) can be respectively folded towards each other via the rotation point at the connection with the third lower frame (23). In addition, the first foldable part (31) is arranged between the first upper frame (11) and the first lower frame (21), and the second foldable part (32) is arranged between the second upper frame (12) and the second lower frame (22). When the first upper frame (11) is folded upward, the second lower frame (22) is driven to be folded upward. At the same time, the second upper frame (12) applies a downward force to the end of the first upper frame (11) in proximity to the first bendable part (13) to drive the first sub-rod (3111) to move downward via the first bendable part (13). In addition, the middle part of the third sub-rod (3113) can be rotated and connected with the middle part of the first supporting rod (312). When the first sub-rod (3111) moves downward, the third sub-rod (3113) is driven to be rotated at the connection between the third sub-rod (3113) and the first supporting rod (312). As the third sub-rod (3113) can be rotated and connected with the 2rd sub-rod (3112), the first sub-rod (3111) can be rotated and connected with the first upper frame (11), and the second sub-rod (3112) can be rotated and connected with the first lower frame (21), when the third sub-rod (3113) rotates, the second sub-rod (3112) is pulled to drive the first lower frame (21) be folded upward. Moreover, the first supporting rod (312) is fixed and connected with the third lower frame (23), in the folded state, the first upper frame (11), the second upper frame (12), the first lower frame (21) and the second lower frame (22) are in the same angle of inclination with the first supporting rod (312) so that the sleeping basket can be tilted towards one direction to fit in the vehicle frame for the convenience of storage.

In yet another aspect, the second foldable part (32) also comprises a third connecting rod (322), wherein, one end of the third connecting rod (322) can be rotated and connected with the second upper frame (12), and the other end of the third connecting rod (322) can be rotated and connected with the connection between the second lower frame (22) and the third lower frame (23).

In this example, the other end of the third connecting rod (322) can be rotated and connected with the connection between the second lower frame (22) and the third lower frame (23). The connections between the second foldable part (32) and the upper (1)/lower frame (2) are disperse with even stress. Therefore, the structure is more stable and reliable, less prone to deformation.

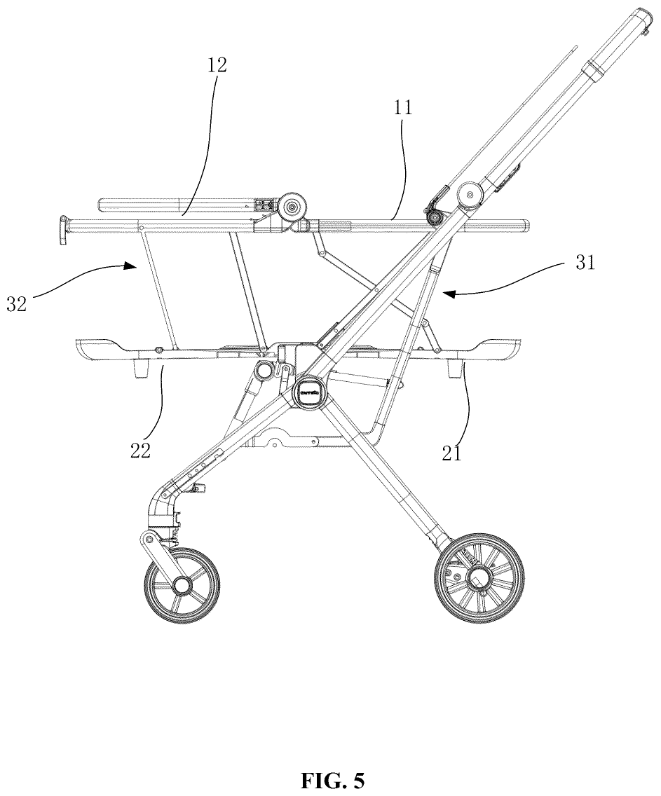

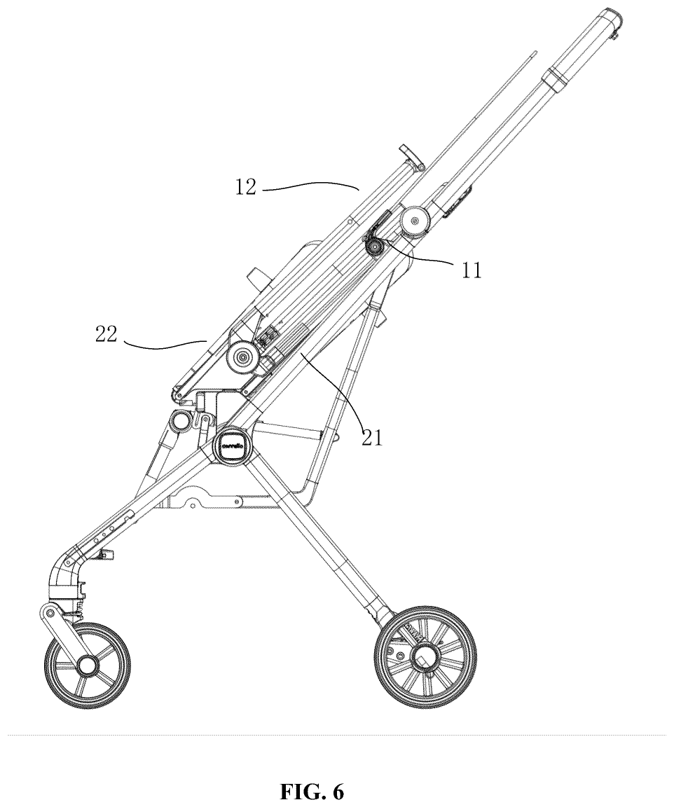

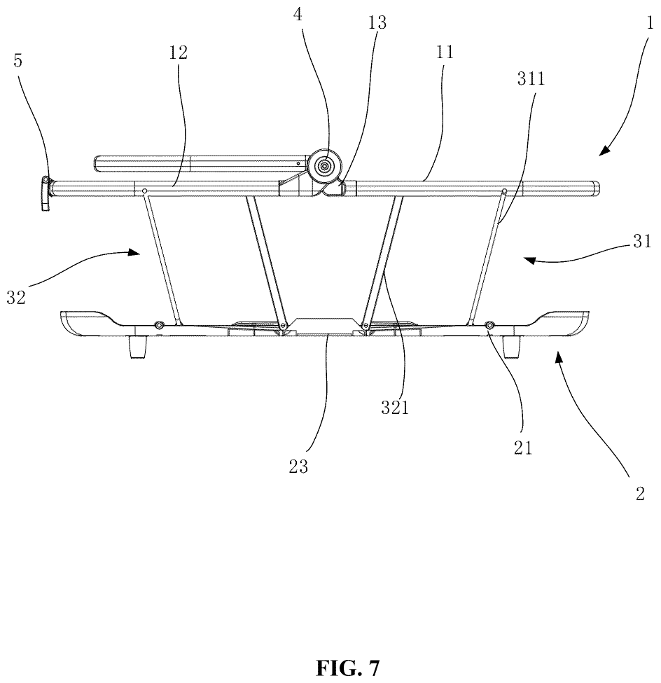

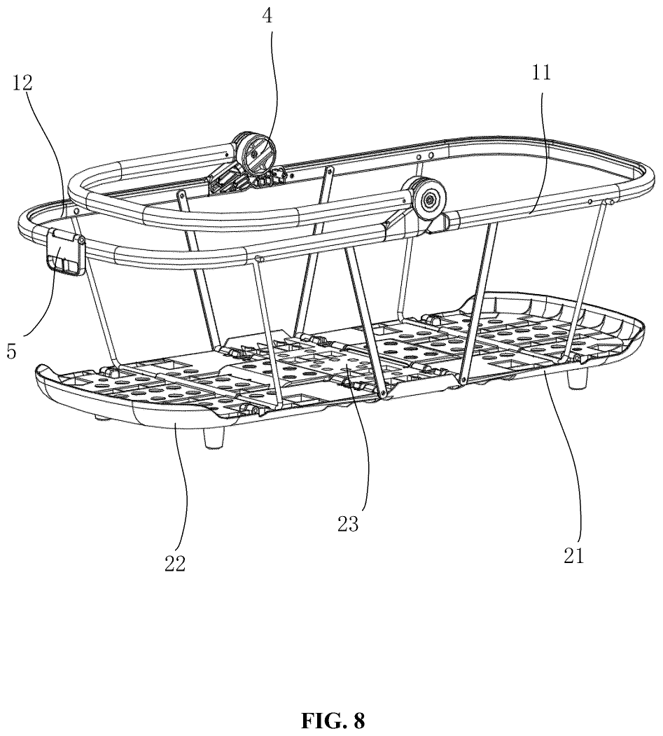

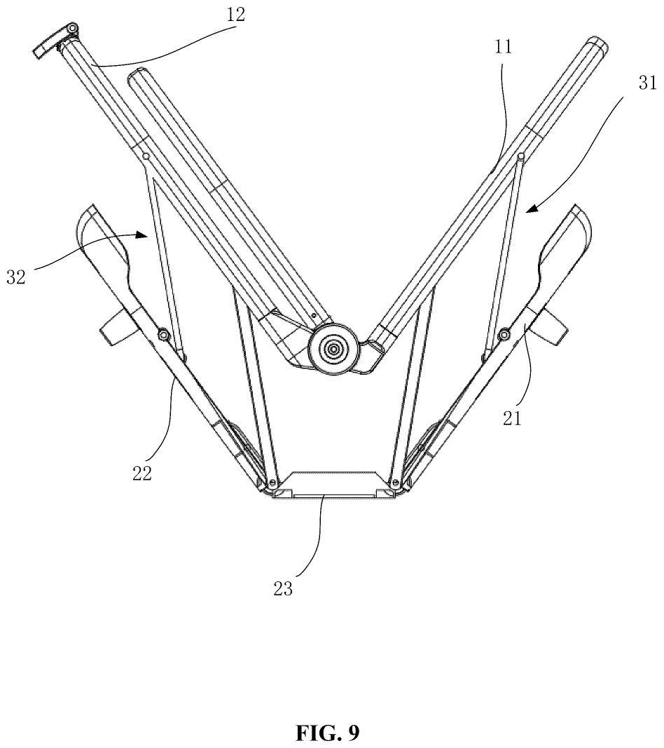

As shown in FIGS. 5 and 6, this embodiment also provides a stroller, which comprises the foldable sleeping basket. FIGS. 7 through 9 illustrate an embodiment comprising a foldable sleeping basket, wherein, the first foldable part (31) comprises a first connecting rod (311), wherein, one end of the first connecting rod (311) can be rotated and connected with the first upper frame (11), and the other end of the first connecting rod (311) can be rotated and connected with the first lower frame (21).

In an exemplary aspect, one end of the first connecting rod (311) is connected with the middle part of the first upper frame (11). The upper frame (1) and the lower frame (2) are under even stress and less prone to deformation. The first foldable part (31) links to the folding motion of the first upper frame (11) and the first lower frame (21) via the first connecting rod (311) arranged between the first upper frame (11) and the first lower frame (21), with simple structure and lower production cost.

In another aspect, the first foldable part (31) also comprises a second connecting rod (321), wherein, one end of the second connecting rod (321) can be rotated and connected with the first upper frame (11), and the other end of the second connecting rod (321) can be rotated and connected with the connection between the first lower frame (21) and the third lower frame (23).

In this plan, the other end of the second connecting rod (321) can be rotated and connected with the connection between the first lower frame (21) and the third lower frame (23). The connections between the first foldable part (31) and the upper (1)/lower frame (2) are disperse, with even stress. Therefore, the structure is more stable and reliable, less prone to deformation.

In yet another aspect, the second foldable part (32) is arranged symmetrically with the first foldable part (31).

In this plan, the second foldable part (32) is arranged symmetrically with the first foldable part (31). The sleeping basket is simple in structure and low in production cost.

This embodiment also provides a stroller, which also comprises a foldable sleeping basket.

In this example, for the sleeping basket on the stroller, the first upper frame (11) is connected with the second upper frame (12) via the first bendable part (13), and can also be folded upward via the rotation point at the connection with the first bendable part (13). The first lower frame (21) and the second lower frame (22) can be respectively folded towards each other via the rotation point at the connection with the third lower frame (23). In addition, the first foldable part (31) is arranged between the first upper frame (11) and the first lower frame (21), and the second foldable part (32) is arranged between the second upper frame (12) and the second lower frame (22). When the first upper frame (11) is folded upward via the rotation point at the connection with the first bendable part (13), the first foldable part (31) drives the first lower frame (21) to be folded upward via the rotating point at the connection with the third lower frame (23). Similarly, when the second upper frame (12) is folded upward, the second lower frame (22) is driven to be folded downward to reduce the space occupied by the sleeping basket for the ease of storage. When it is necessary to unfold the foldable sleeping basket for use, the first upper frame (11) and the second upper frame (12) are pulled, which drives the folding of the first lower frame (21) and the second lower frame (22). As the third lower frame (23) is arranged between the first lower frame (21) and the second lower frame (22), the lower frame (2) is folded in three section. Of course, in other embodiments, the third lower frame (23) may be of a two or more section structure, with more smooth transition at the bend. The third lower frame (23) makes more accommodation space between the first lower frame (21) and the second lower frame (22). For one thing, after being folded, the first lower frame (21), the second lower frame (22) and the third lower frame (23) are in the U shape. Compared to the two-section V-shape frame, less space is occupied. For another, the head and the cloth cover are less prone to damaged due to extrusion and are flatter after the sleeping basket is folded.

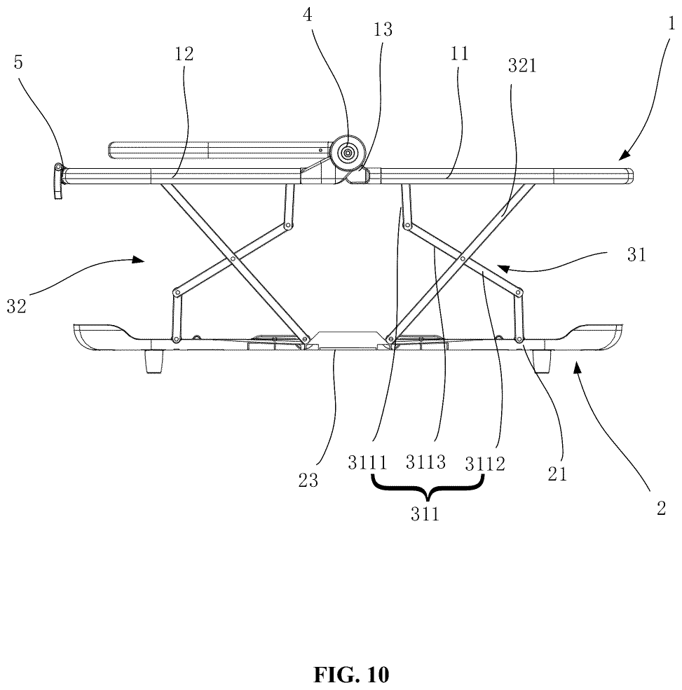

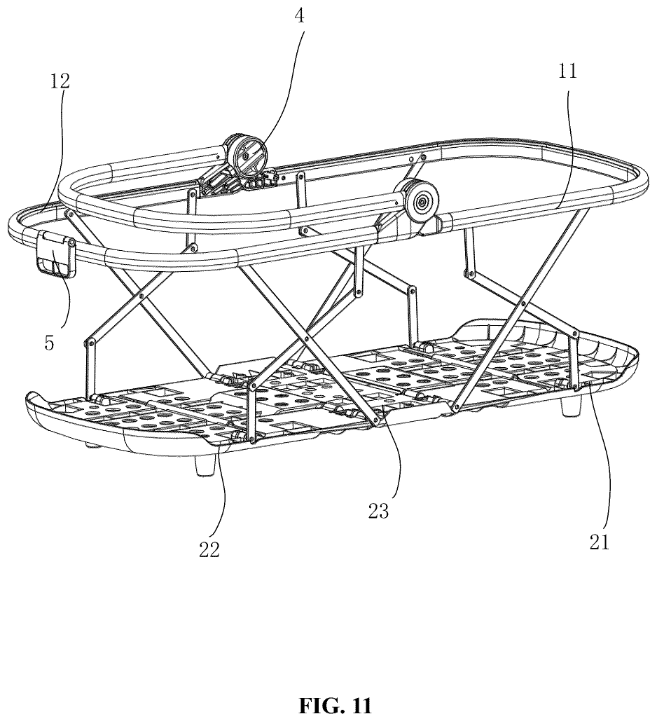

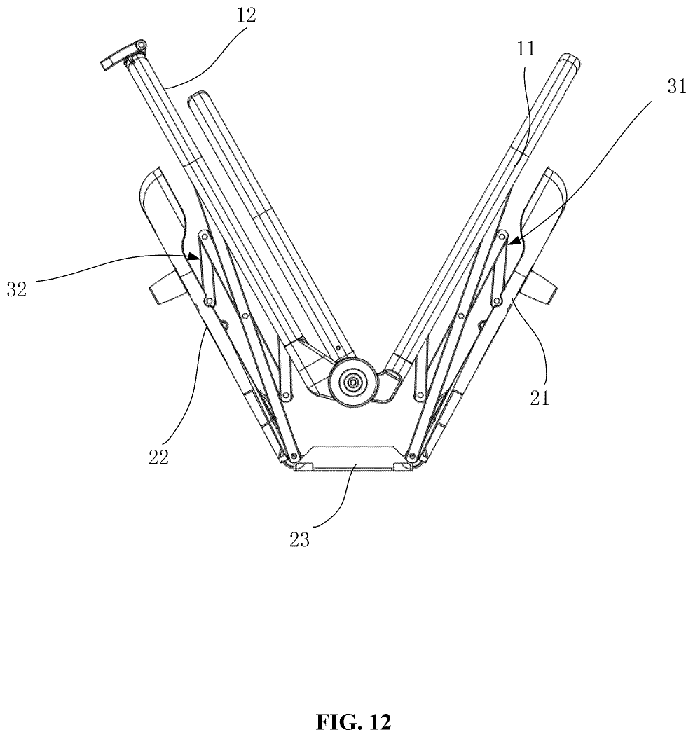

FIGS. 10 through 12 illustrate aspects of a non-limiting embodiment comprising a foldable sleeping basket, wherein, the first foldable part (31) comprises a first connecting rod (311) and a second connection rod (321), wherein, one end of the second connecting rod (321) can be rotated and connected with the first upper frame (11), and the other end of the second connecting rod (321) can be rotated and connected with the connection between the first lower frame (21) and the third lower frame (23). The first connecting rod (311) comprises a first sub-rob (3111), a second sub-rod (3112) and a third sub-rod (3113), wherein, the middle part of the third sub-rod (3113) can be rotated and connected with the middle part of the second connecting rod (321), one end of the third sub-rod (3113) can be rotated and connected with one end of the first sub-rod (3111), the other end of the third sub-rod (3113) can be rotated and connected with one end of the second sub-rod (3112), the other end of the first sub-rod (3111) can be rotated and connected with the part of the first upper frame (11) in proximity to the first bendable part (13), and the other end of the second sub-rod (3112) can be rotated and connected with the part of the first lower frame (21) away from the third lower frame (23).

In this plan, both ends of the second connecting rod (321) can be rotated and connected with the first upper frame (11) and the connecting between the first lower frame (21) and the third lower frame (23). When the first upper frame (11) is folded upward, the second connecting rod (321) is driven to rotate via the rotating point at the connection between the first lower frame (21) and the third lower frame (23). In addition, the middle part of the third sub-rod (3113) can be rotated and connected with the middle part of the second connecting rod (321). When the second connecting rod (321) rotates, the third sub-rod (3113) is driven to rotate at the connection between the third sub-rod (3113) and the second connecting rod (321). As the third sub-rod (3113) can be rotated and connected with the first sub-rod (3111) and the 2rd sub-rod (3112), the first sub-rod (3111) can be rotated and connected with the first upper frame (11), and the second sub-rod (3112) can be rotated and connected with the first lower frame (21), when the third sub-rod (3113) rotates, the second sub-rod (3112) is pulled to drive the first lower frame (21) be folded upward. In the structure, the first foldable part (31) is in the X shape, with even stress at the connections with the first upper frame (11) and the first lower frame (21). The structure is more stable and reliable.

In one aspect, the second foldable part (32) is arranged symmetrically with the first foldable part (31).

The second foldable part (32) is arranged symmetrically with the first foldable part (31). The sleeping basket is simple in structure and low in production cost. Of course, in other embodiments, the first foldable part (31) can adopt the method in Embodiment 2, and the second foldable part (32) can adopt the disclosure described to form an asymmetric arrangement.

This example also provides a stroller, which comprises the above foldable sleeping basket.

Although the specific mode of execution of the invention and aspects of the disclosed embodiments are provided above, those skilled in the art should understand that this is only an illustration and the protection scope of this utility scope is defined by the attached claims. Those skilled in the art may make a variety of changes or modifications to these embodiments without departing from the principles and substance of the invention, but these changes and modifications are within the scope thereof.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A foldable sleeping basket comprising:
an upper frame having a first upper frame portion, a second upper frame portion, said first and second upper frame portions being foldable towards one another by way of a lockable upper frame pivot assembly;
a lower frame having a first lower frame portion, a second lower frame portion, and a third lower frame portion, said first and third lower frame portions being foldable towards each other by way of a first lower frame pivot assembly joining the first and second lower frame portions and a second lower frame pivot assembly joining the third and second lower frame portions, respectively;
a frame connector assembly comprising a plurality of connecting rods and sub-rods mechanically coupling said upper frame portions and said lower frame portions to one another;
said foldable sleeping basket being foldably transitionable between an extended state and a collapsed state;
wherein in the extended state the foldable sleeping basket the first and second upper frame portions are open about said upper frame pivot assembly and the lockable upper frame pivot assembly is locked, and wherein the first, second and third lower frame portions are open about said first and second lower frame pivot assemblies; and
wherein in the collapsed state the foldable sleeping basket the first and second upper frame portions are folded towards one another about said upper frame pivot assembly and the lockable upper frame pivot assembly is unlocked, and wherein the first, second and third lower frame portions are folded towards one another about said first and second lower frame pivot assemblies, respectively.

2. The foldable sleeping basket of claim 1, configured and arranged to mechanically lock into a mobile stroller for transporting the same.

3. The foldable sleeping basket of claim 1, said lockable upper frame pivot assembly preventing movement from said extended state to said collapsed state.

4. The foldable sleeping basket of claim 1, further comprising an unlocking mechanism for unlocking said lockable upper frame pivot assembly, which permits movement from said extended state to said collapsed state.

5. The foldable sleeping basket of claim 1, wherein said frame connector assembly couples at least one or more of said plurality of connecting rods and sub-rods to upper frame coupling points on said upper frame and to lower frame coupling points on said lower frame.

6. The foldable sleeping basket of claim 5, wherein at least one of said plurality of connecting rods and sub-rods comprise rotatable mechanical endpoints to permit pivoting movement of said at least one of said plurality of connecting rods and sub-rods with respect to another member of said upper or lower frames.

7. A stroller, comprising a wheeled transportation frame, a handle, and the foldable sleeping basket of claim 1.

8. A foldable stroller and sleeping basket apparatus, comprising:
a stroller frame having a plurality of stroller frame coupling points configured to mechanically couple to a corresponding plurality of folding basket coupling points;
a stroller handle proximal to an upper portion of said stroller frame;
a plurality of stroller wheels proximal to a lower portion of said stroller frame; and
a foldable sleeping basket comprising:
an upper sleeping basket frame and a lower sleeping basket frame;
wherein said upper sleeping basket frame includes a first upper frame portion, a second upper frame portion, said first and second upper frame portions being foldable towards one another by way of a lockable upper frame pivot assembly;
wherein said lower basket frame includes a first lower frame portion, a second lower frame portion, and a third lower frame portion, said first and third lower frame portions being foldable towards each other by way of a first lower frame pivot assembly joining the first and second lower frame portions and a second lower frame pivot assembly joining the third and second lower frame portions, respectively;
wherein said foldable sleeping basket is foldably transitionable between an extended state and a collapsed state;
wherein in the extended state the foldable sleeping basket the first and second upper frame portions are open about said upper frame pivot assembly and the lockable upper frame pivot assembly is locked, and wherein the first, second and third lower frame portions are open about said first and second lower frame pivot assemblies; and
wherein in the collapsed state the foldable sleeping basket the first and second upper frame portions are folded towards one another about said upper frame pivot assembly and the lockable upper frame pivot assembly is unlocked, and wherein the first, second and third lower frame portions are folded towards one another about said first and second lower frame pivot assemblies, respectively.
